(19) United States
(12) Patent Application Publication
(10) Pub. No.: US 2025/0156125 A1
(43) Pub. Date: May 15, 2025

(54) PRINTING SYSTEM, NON-TRANSITORY COMPUTER-READABLE STORAGE MEDIUM STORING PRINTING PROGRAM, AND METHOD OF PRODUCING PRINTED MATTER

(71) Applicant: SEIKO EPSON CORPORATION, Tokyo (JP)

(72) Inventors: Akira OKURA, Chino (JP); Yuji ISHIKAWA, Matsumoto (JP); Takahiro KAMADA, Matsumoto (JP); Mitsuhiro YAMASHITA, Matsumoto (JP); Takuya ONO, Shiojiri (JP)

(21) Appl. No.: 18/942,830

(22) Filed: Nov. 11, 2024

(30) Foreign Application Priority Data
Nov. 13, 2023 (JP) 2023-192701

(51) Int. Cl. G06F 3/12

(52) U.S. Cl. CPC G06F 3/1208; G06F 3/1205; G06F 3/1252; G06F 3/1256

(57) ABSTRACT

Provided is a printing system including a display configured to provide a plurality of patterns including a first pattern in which a first image and a second image are printed on the same surface side of a transparent medium and a second pattern in which the first image and the second image are respectively printed on opposite sides of the transparent medium, and a printer configured to execute printing according to a pattern selected by a user from the patterns being provided.

The present application is based on, and claims priority from JP Application Serial Number 2023-192701, filed Nov. 13, 2023, the disclosure of which is hereby incorporated by reference herein in its entirety.

### BACKGROUND

### 1. Technical Field

The present disclosure relates to a printing system, a non-transitory computer-readable storage medium storing a printing program, and a method of producing printed matter.

### 2. Related Art

Hitherto, it has been known to display a preview of an image to be printed by using special color ink. JP-A-2019-220838 describes that a preview image is generated and displayed, the preview image being acquired by overlapping a plurality of image layers included in a printing job and corresponding to an overlapping order specified by a user.

It has been desired to provide a configuration for assisting a user in determining how to allocate each image to a front surface or a back surface of a transparent medium having the front surface and the back surface on which printing can be executed.

### SUMMARY

In order to solve the above-mentioned problem, a printing system including a display configured to provide a plurality of patterns including a first pattern in which a first image and a second image are printed on the same surface side of a transparent medium and a second pattern in which the first image and the second image are respectively printed on opposite sides of the transparent medium, and a printer configured to execute printing according to a pattern selected by a user from the patterns being provided.

In order to solve the above-mentioned problem, a non-transitory computer-readable storage medium storing a printing program causes a computer to achieve a function of causing a display to provide a plurality of patterns including a first pattern in which a first image and a second image are printed on the same surface side of a transparent medium and a second pattern in which the first image and the second image are respectively printed on opposite sides of the transparent medium, and a function of causing a printer to execute printing according to a pattern selected by a user from the patterns being provided.

In order to solve the above-mentioned problem, a method of producing a printed matter includes providing a plurality of patterns including a first pattern in which a first image and a second image are printed on the same surface side of a transparent medium and a second pattern in which the first image and the second image are respectively printed on opposite sides of the transparent medium, and executing printing according to a pattern selected by a user from the patterns being provided.

### BRIEF DESCRIPTION OF THE DRAWINGS

FIG. 1 is a block diagram of a printing system.

FIG. 2 is a block diagram of a user terminal.

FIG. 3 is a block diagram of a server.

FIG. 4 is a block diagram of a printer.

FIG. 5 is a diagram illustrating an example of an image created by a user and an object included in the image.

FIG. 6 is a flowchart of display priority degree setting processing.

FIG. 7 is a diagram illustrating an example of an allocation pattern.

FIG. 8 is a diagram illustrating an example of an adopted pattern.

FIG. 9 is a diagram illustrating an example of an excluded pattern.

FIG. 10 is a diagram illustrating an example in which an object with a high display priority degree includes an object with a low display priority degree.

FIG. 11 is a diagram illustrating an example of the allocation pattern.

FIG. 12 is a diagram illustrating an example of the allocation pattern.

FIG. 13 is a diagram illustrating an example of a printed matter.

FIG. 14 is a flowchart of pattern generation processing.

FIG. 15 is a diagram illustrating an example of a pattern provision screen.

### DESCRIPTION OF EMBODIMENTS

Herein, an embodiment of the present disclosure is described according to the following order.
(1) Configuration of Printing System:
(1-1) Configuration of User Terminal:
(1-2) Configuration of Server:
(1-3) Configuration of Printer:
(2) Pattern Provision Processing:
(3) Other Embodiments:

### (1) Configuration of Printing System

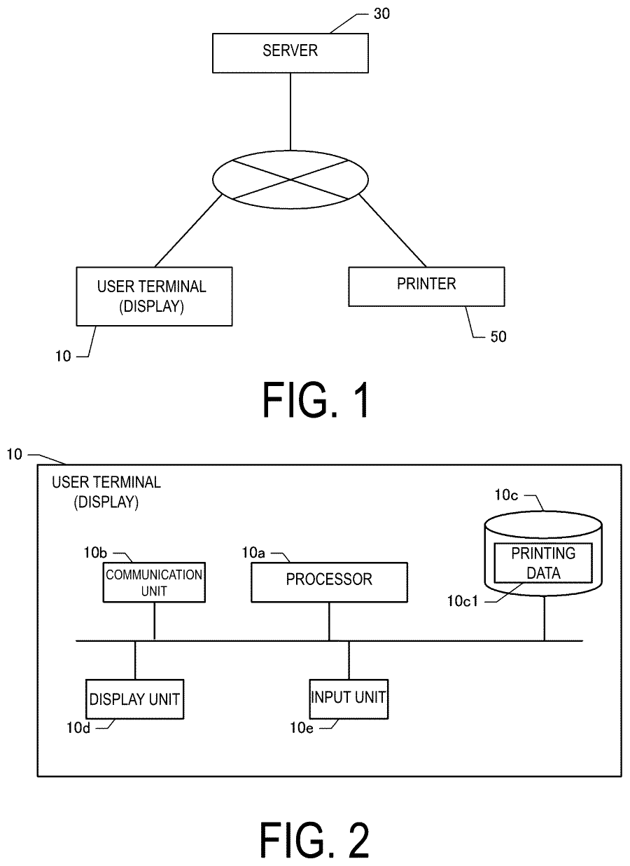

FIG. 1 is a block diagram illustrating a configuration of a printing system according to an embodiment of the present disclosure. The printing system at least includes a printer 50 and a user terminal 10. The user terminal 10 functions as a display that provides an allocation pattern of an image to be printed on a transparent medium by the printer 50. In the present embodiment, the user terminal 10 and the printer 50 are configured to mutually transmit printing data and the like via a server 30. Note that, in another embodiment, the user terminal 10 and the printer 50 are configured to directly transmit and receive various types of data without the server 30, or the user terminal 10 and the printer 50 may be configured to transmit and receive data via another server or terminal. The number of devices illustrated in FIG. 1 is merely an example, and the number thereof is not limited. Each may be configured by a plurality of devices.

Those devices can communicate with each other via a network. A mode of the network may be various modes such as wireless communication and wired communication. In the present embodiment, the printing system is used when a printed matter is produced according to an order from a customer. In the present embodiment, the user terminal 10 is a terminal operated by a user being a customer. The user terminal 10 is installed, for example, at a store front of a store that receives an order of a user-customized printed material, and the printer 50 and the server 30 are installed, for example, in a back office of the store. The back office may be a location continuous with the store front, or may be a location away from the store, such as a printing factory. Further, the user terminal 10 and the printer 50 are installed in the store, and the server 30 may be installed at a remote location away from the store.

In the present embodiment, a customer designs printing data by using the user terminal 10 installed at the store front, and places an order. The printing data generated by the user design is transmitted to the server 30. The server 30 executes progress management for printing of the printer 50, or the like. The printing data is stored in the server 30, and the server 30 transmits the printing data to the printer 50 to execute printing. At the back office, a printing worker executes an operation for executing printing according to an order from a user by the printer 50.

In the present embodiment, for example, it is assumed that a type of a printed matter produced based on an order is a transparent printing medium (transparent medium) such as an acrylic block and an acrylic panel, and printing is executed thereon to produce a printed matter. Printing can be executed for each of a front surface and a back surface of the transparent medium. A user may instruct printing on the front surface and the back surface of the transparent medium while assuming viewing from the front surface, or may instruct printing on the front surface and the back surface of the transparent medium while assuming viewing from both the front surface and the back surface. In the present embodiment, the former case is assumed.

A three-dimensional expression can be achieved due to the thickness of the transparent medium, and a plurality of patterns such as printing images only on the back surface of the transparent medium, printing images only on the front surface, and allocating and printing images on both the front surface and the back surface are considered. However, it is not easy for a user by themselves to consider each of the patterns. Thus, the printing system of the present embodiment includes a function of providing those patterns and allowing a user to select a desired pattern therefrom with regard to the transparent medium having the front surface and the back surface on which printing can be executed.

### (1-1) Configuration of User Terminal:

FIG. 2 is a block diagram illustrating a configuration of the user terminal 10. In the present embodiment, the user terminal 10 is a terminal used by a user for creating and editing an image to be printed on the transparent medium. The patterns described above are provided by the user terminal 10, and a desired pattern is selected therefrom. The user terminal 10 includes a processor 10a, a communication unit 10b, a non-volatile memory 10c, a display unit 10d, and an input unit 10e. The processor 10a includes a CPU, a ROM, a RAM, and the like, which are omitted in illustration, and can execute various programs recorded in the non-volatile memory 10c and control each of the units of the user terminal 10 and the printer 50.

Note that the processor 10a may be configured by a single chip, may be configured by a plurality of chips, or may be configured as an SoC with various functional blocks. Further, for example, in place of the CPU, an ASIC may be adopted, or a configuration in which a CPU and an ASIC are operated in collaboration may be adopted. When each of the devices of the present embodiment includes a processor, the processor can be achieved in various modes similarly to the processor 10a.

The communication unit 10b includes a communication interface for communicating with an external device according to various communication protocols. The user terminal 10 can communicate with another device via the communication unit 10b. Further, the communication unit 10b includes an interface for communicating with various removable memories mounted to the user terminal 10.

The display unit 10d is a display device that displays a freely selected image. The input unit 10e is a device that executes an input operation by a user, and is configured by, for example, a touch panel or the like. In the present embodiment, it is assumed that the user terminal 10 is a tablet terminal. Thus, it is assumed that the input unit 10e is mainly a touch panel. As a matter of course, a keyboard, a mouse, or the like may be used. In any case, a user can operate the input unit 10e to input an intention of the user while visually recognizing an image and a character displayed by the display unit 10d.

The processor 10a executes a printing program, which is omitted in illustration. The printing program includes an editing application for creating and editing an image to be printed on the transparent medium. When the printing program is executed, the processor 10a achieves a function of allowing a user to create and edit an image to be printed on the transparent medium having both surfaces on which printing can be executed. When a user executes an operation of terminating creation and editing, the processor 10a generates patterns in which each image (object) included in the image created by the user is allocated to both the surfaces of the transparent medium, and provides the patterns to the user. Further, the processor 10a generates printing data 10cl for executing printing in a pattern selected by a user on each of the surfaces of the transparent medium, and transmits the printing data 10c1 to the printer 50 via the server 30. With this, the printer 50 executes printing based on the printing data.

### (1-2) Configuration of Server:

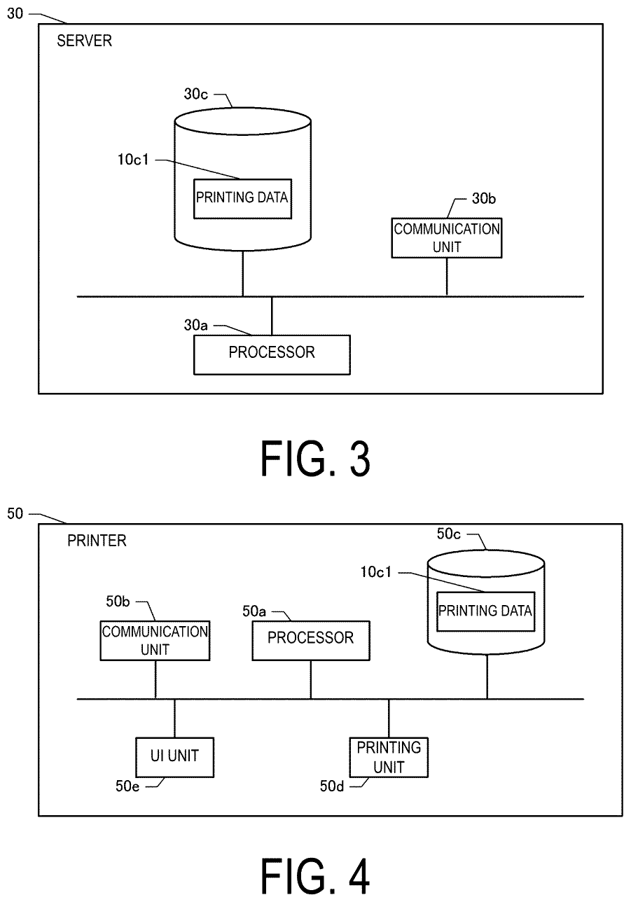

FIG. 3 is a block diagram illustrating a configuration of the server 30. The server 30 includes a processor 30a, a communication unit 30b, and a non-volatile memory 30c. The processor 30a includes a CPU, a ROM, a RAM, and the like, which are omitted in illustration, and can execute various programs recorded in the non-volatile memory 30c and control each of the units of the server 30 and each device coupled to the network.

The communication unit 30b includes a communication interface for communicating with an external device according to various wired or wireless communication protocols. The server 30 can communicate with another device via the communication unit 30b. Note that the communication unit 30b may include an interface for communicating with various removable memories mounted to the server 30.

The server 30 includes the non-volatile memory 30c, and the printing data 10c1 transmitted from the user terminal 10 is recorded in the non-volatile memory 30c. The printer 50 executes printing of the printing data 10cl, and hence the processor 30a transmits the printing data 10cl to the printer 50 to execute printing. Further, the server 30 manages progress of a printing job in the printer 50, based on various pieces of status information transmitted from the printer 50.

### (1-3) Configuration of Printer:

FIG. 4 is a block diagram illustrating a configuration of the printer 50. The printer 50 includes a processor 50a, a communication unit 50b, a non-volatile memory 50c, a printing unit 50d, and an UI unit 50e. The processor 50a includes a CPU, a ROM, a RAM, and the like, which are omitted in illustration, and can execute a control program recorded in the non-volatile memory 50c and control each of the units of the printer 50.

The communication unit 50b includes a communication interface for communicating with an external device according to various wired or wireless communication protocols. The printer 50 can communicate with another device via the communication unit 50b. Note that the communication unit 50b may include an interface for communicating with various removable memories mounted to the printer 50.

The printing unit 50d executes printing on various printing media dealt with at a store. The printing unit 50d includes an actuator for executing printing on a printing medium, various devices, a sensor, a driving circuit, a mechanical component, and the like. The sensor includes a sensor that detects various detection targets that may be changed in the printer 50. Examples thereof include a sensor that detects a remaining amount of printing media, a sensor that detects a remaining amount of ink of each color used for printing, and the like.

The printer 50 may execute printing on the transparent medium by using ink of process colors including cyan, magenta, yellow, and black and special color ink such as clear ink and white color ink. A printing worker sets the transparent medium in the printer 50 so that one surface thereof is a printing surface, and then causes the printer 50 to execute printing. After printing, the transparent medium is reversed and set, and the printer 50 is caused to execute printing. With this, printing can be executed on each of the front surface and the back surface of the transparent medium.

### (2) Pattern Provision Processing

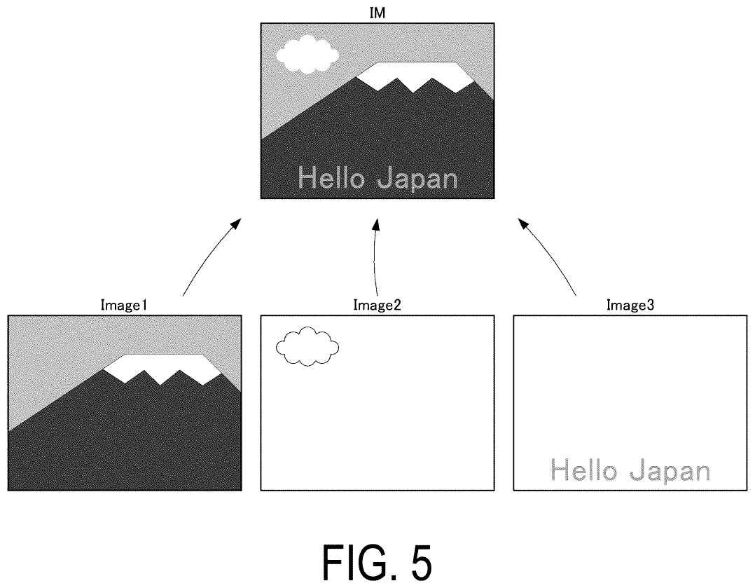

A user can create and edit an image to be printed on the transparent medium by using an image prepared by themselves or an image prepared in advance in an editing application. An image IM illustrated in FIG. 5 is an example of an image created by a user. The image IM in this example is created by using Image 1, Image 2, and Image 3. Specifically, Image 1 is a scenery image object (a sky and a mountain) across the entire printing target surface of the transparent medium, Image 2 is an object indicating cloud (a region other than the cloud is transparent), and Image 3 is a character object (a region other than the characters is transparent). The cloud object in Image 2 and the character object in Image 3 are arranged at positions that do not interfere with each other. First, a user arranges Image 1 in an editing region of the editing application, and then arranges the cloud object in Image 2 and the character object in Image 3 without interfering with each other on Image 1. With this, the image IM can be created. Therefore, among the three images, Image 1 has the lowest display priority degree, and Image 2 and Image 3 have display priority degrees higher than that of Image 1.

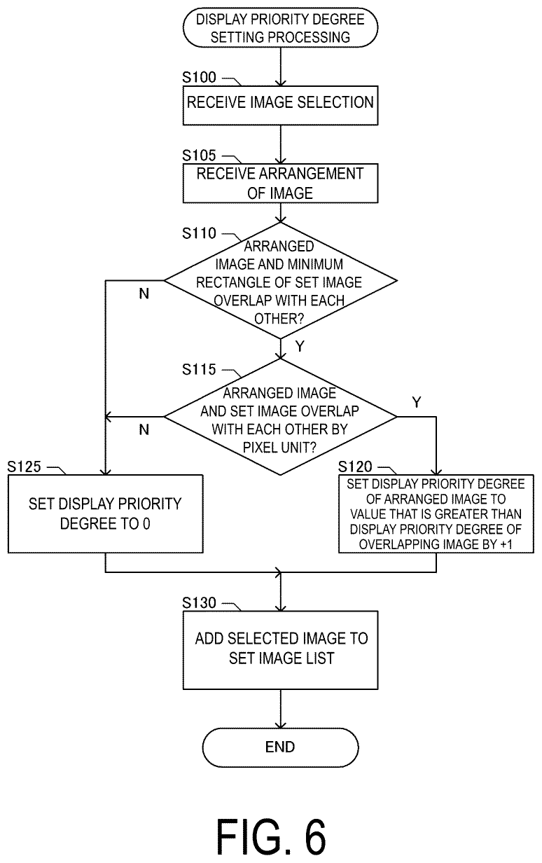

FIG. 6 is a flowchart of display priority degree setting processing. The display priority degree setting processing is executed when a user newly arranges an object in the editing application. Note that, when a user changes a position of an arranged object to change presence or absence of interference between objects, or a user changes an overlapping order of arranged objects, processing of updating the display priority degree is also executed.

In the display priority degree setting processing, when a user executes an operation of selecting an image, the processor 10a receives the selected image (Step S100). In other words, when a user executes an operation of specifying a storage location of an image to be used and a file of the image through the editing application, the processor 10a receives the selected image. Subsequently, when a user executes an operation of arranging the image, the processor 10a receives the arrangement (Step S105). In other words, when an object is arranged in a region for editing an image in the editing application, the processor 10a acquires a position at which the object is arranged (for example, upper left coordinates of a rectangle circumscribing the object), and a size of the object (a width and a height of the rectangle).

Subsequently, the processor 10a determines whether the arranged image and the minimum rectangle of the set image overlap with each other (Step S110). In other words, the processor 10a determines whether the rectangle circumscribing the new object that is currently arranged and the rectangle circumscribing the object that is previously arranged interfere with each other. When it is determined that they overlap with each other in Step S110, the processor 10a determines the arranged image and the set image overlap with each other by a pixel unit (Step S115). In other words, the processor 10a determines whether the contours of the objects interfere with each other.

When it is determined that they overlap with each other in Step S115, the processor 10a sets the display priority degree of the arranged image so that the display priority degree is higher than that of the overlapping image by +1 (Step S120). The lowest value of the display priority degree is 0. The greater numerical value indicates the higher display priority degree. The processor 10a sets the display priority degree of the arranged image to a value greater than the display priority degree of the set image, which is determined to overlap therewith in Step S115, by 1. Note that, when there are a plurality of overlapping set images, a value that is greater than the display priority degree of the image with the highest display priority degree by 1 is set as the display priority degree of the set image.

When it is not determined that they overlap with each other in Step S110, or it is not determined that they overlap with each other in Step S115, the processor 10a sets the display priority degree to 0 (Step S125).

After execution of Step S120 or execution of Step S125, the processor 10a adds the arranged image to a set image list (Step S130). The image list is a list of the images that are previously arranged, and a display priority, an arrangement position, a size, and the like are recorded for each object. Therefore, in Step S130, the new object that is currently arranged, and the display priority degree, the arrangement coordinates, and the size thereof are added to the image list. For example, when the image IM illustrated in FIG. 5 is created through the processing described above, the display priority degree of Image 2 has a value greater than the display priority degree of Image 1 that interferes with Image 2 and is present as a layer below Image 2. Similarly, the display priority degree of Image 3 has a value greater than the display priority degree of Image 1.

A three-dimensional expression can be achieved due to the thickness of the transparent medium, and a user can select printing objects only on the back surface of the transparent medium, printing objects only on the front surface, or allocating and printing objects on both the front surface and the back surface are considered. However, it is not easy for a user by themselves to consider each of the patterns for the image in which the plurality of objects are arranged. Thus, the processor 10a acquires patterns achieved by allocation combinations of the objects, based on the above-mentioned image list that is set based on the image created by the user, and provides the patterns to the user.

A case of focusing on two objects among a plurality of objects included in an image created by a user is examined. It is assumed that an image including one object is referred to as a first image and an image including the other object is referred to as a second image. In this case, classification can be roughly made into a first pattern in which the first image and the second image are printed on the same surface side of the transparent medium and a second pattern in which the first image and the second image are respectively printed on the opposite sides of the transparent medium. The processor 10a provides those patterns to a user. With this, with regard to printing on the transparent medium having the front surface and the back surface on which printing can be executed, a user can recognize the allocation patterns of the two images (objects) on the front surface and the back surface of the transparent medium.

Further, a case of focusing on three objects among a plurality of objects included in an image created by a user is examined. It is assumed that an image including a third object is referred to as a third image. In this case, classification can be roughly made into a first pattern in which the first image, the second image, and the third image are printed on the same surface side of the transparent medium, a second pattern in which the first image, and the second image and the third image are respectively printed on the opposite sides of the transparent medium, a third pattern in which the first image and the third image, and the second image are respectively printed on the opposite sides of the transparent medium, and a fourth pattern in which the third image, and the first image and the second image are respectively printed on the opposite sides of the transparent medium. The processor 10a provides those patterns to a user. With this, with regard to printing on the transparent medium having the front surface and the back surface on which printing can be executed, a user can recognize the allocation patterns of the three images (objects) on the front surface and the back surface of the transparent medium.

Note that those patterns can further be finely classified by distinguishing the front surface and the back surface from each other. For example, the first pattern can be finely classified into a pattern in which all the images are printed on the front surface and a pattern in which all the images are printed on the back surface (the images printed horizontally reversed on the back surface on the transparent medium are viewed from the front surface). In the present embodiment, the processor 10a provides those patterns to a user while distinguishing them.

Further, when printing is executed with allocation to the front surface and the back surface, a pattern causing a printing result that contradicts with an image (object) overlapping order specified by a user is excluded, in other words, a pattern that does not satisfy the order of the display priority degrees of the objects is excluded. Then, only a pattern that satisfies the order of the display priority degrees is provided to a user.

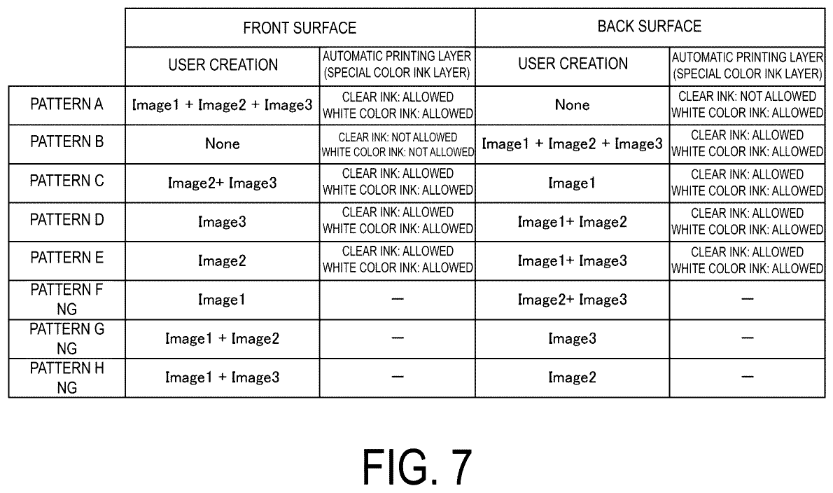

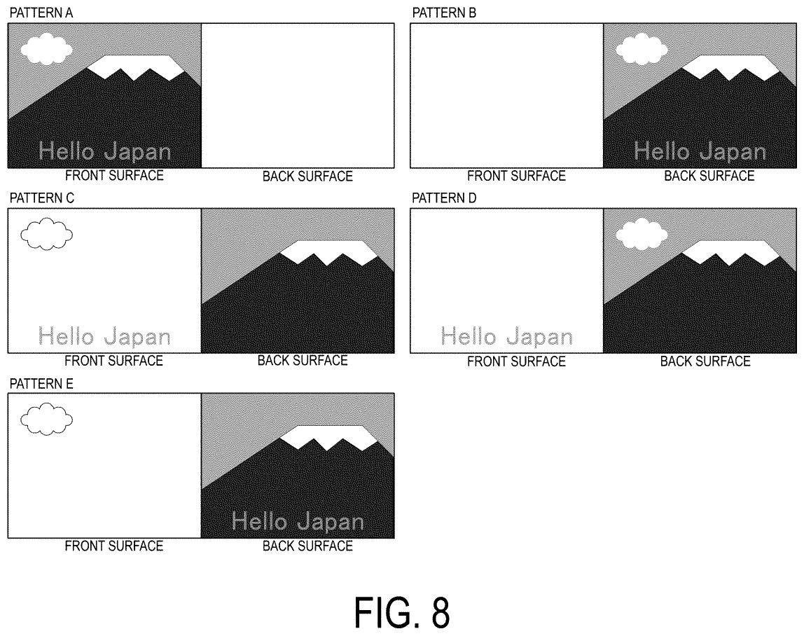

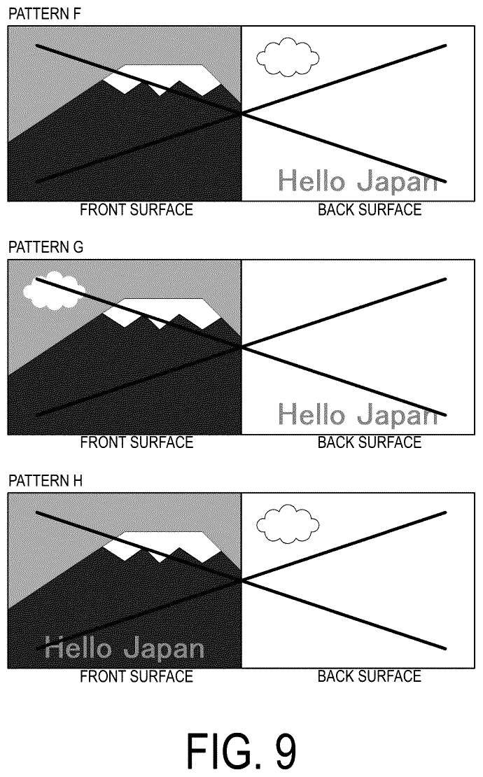

FIG. 7 illustrates eight patterns being allocation patterns of the three objects illustrated in FIG. 5, and FIG. 8 and FIG. 9 are diagrams for illustrating and describing allocation in each of the patterns. For example, a pattern A is a pattern in which all the three objects are printed on the front surface, and a pattern B is a pattern in which all the three objects are reversed and printed on the back surface. The patterns A and B correspond to the first pattern. Note that the pattern A and the pattern B are different from each other in the following manner. Specifically, the scenery image, the cloud, and the characters are viewed without interposing the thickness of the transparent medium (the pattern A), or they are viewed via the thickness of the transparent medium (the pattern B).

Patterns C to E are patterns in which the three images are respectively allocated on the front surface and the back surface. The pattern C has an effect that the cloud and the characters appear to float above the scenery image. Similarly, the pattern D has an effect that only the characters appear to float above the scenery image and the cloud, and the pattern E has an effect that only the cloud appears to float above the scenery image and the characters.

The patterns A to E are patterns that are viewed as illustrated in the image IM (in other words, the order of the display priority degrees is satisfied) when the transparent medium on which printing is executed as described above is viewed from the front surface side.

In contrast, the patterns F to H are patterns that are not viewed as illustrated in the image IM (in other words, the order of the display priority degrees is not satisfied) when the transparent medium on which printing is executed as described above is viewed from the front surface side. Specifically, for example, the pattern F is a pattern in which reversed images of Image 2 and Image 3 are printed on the back surface and Image 1 is printed on the front surface. When the transparent medium printed as described above is viewed from the front surface side, Image 2 and Image 3 are not visually recognized. Even when it is viewed from the back surface side, Image 1, Image 2, and Image 3 are reversed images. Thus, the pattern provides an image different from the image IM. Thus, the processor 10a excludes those patterns causing a printing result that contradicts with an image (object) overlapping order specified by a user, in advance, and provides the remaining patterns.

Note that, when Image 1 is the first image, Image 2 is the second image, and Image 3 is the third image, the pattern A and the pattern B correspond to the first pattern described above. The pattern C and the pattern F correspond to the second pattern, the pattern E and the pattern H correspond to the third pattern, and the pattern D and the pattern G correspond to the fourth pattern.

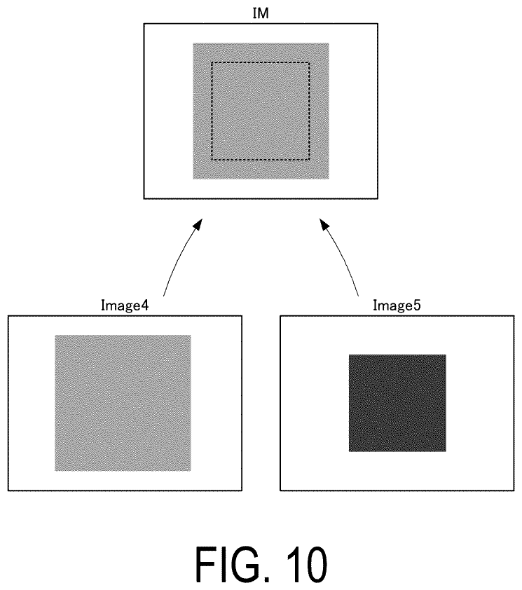

Note that, as illustrated in FIG. 10, when an image including an object of Image 4 and an object (Image 5) that has a display priority degree lower than Image 4 and is completely included in the object of Image 4 is created, the processor 10a provides a pattern in which the objects are separated from each other on the front surface and the back surface as an expression utilizing the thickness of the transparent medium. In the example of FIG. 10, an image created by a user may include an object other than Image 4 and Image 5, but the following description is made on a case of focusing on Image 4 and Image 5.

In this example, a user specifies that Image 4 (the first image) is a layer (a layer having a higher display priority degree) above Image 5 (the second image). Further, the printing region of the object of Image 4 (the first image) (in other words, a region onto which ink is ejected) includes the printing region of the object of Image 5 (the second image).

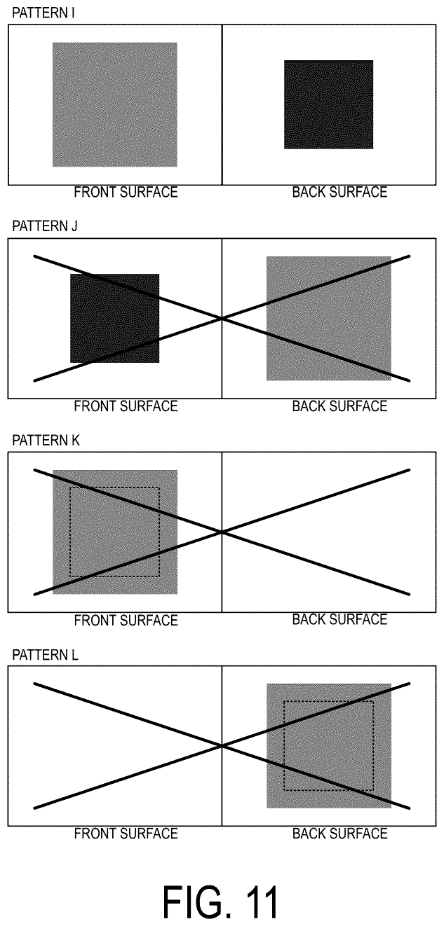

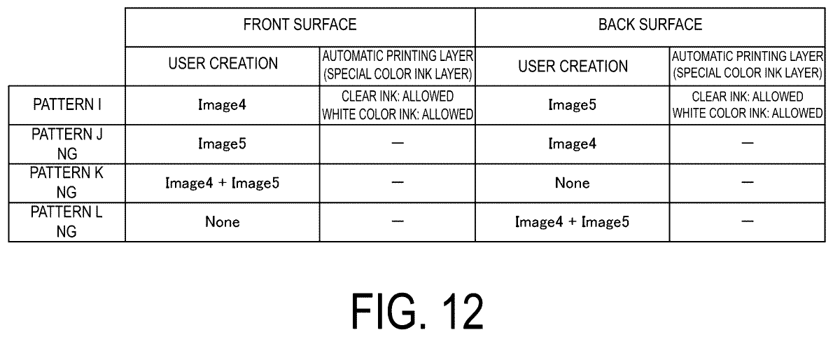

In such a case, as allocation patterns, there are four patterns including patterns I to L illustrated in FIG. 11 and FIG. 12. However, among those, the processor 10a excludes patterns in which Image 4 (the first image) and Image 5 (the second image) are printed on the same surface side, from the patterns provided to a user. Specifically, the processor 10a excludes the pattern K and the pattern L.

Further, the processor 10a excludes pattern in which Image 4 (the first image) is printed on the back surface of the transparent medium and Image 5 (the second image) is printed on the front surface of the transparent medium (in other words, a pattern that contradicts with an image overlapping order), from the patterns provided to a user. Specifically, the processor 10a excludes the pattern J.

After excluding those excluded patterns, the processor 10a provides a user with a remaining pattern in which Image 4 (the first image) is printed on the front surface of the transparent medium and Image 5 (the second image) is printed on the back surface of the transparent medium. Specifically, the processor 10a provides the pattern I to a user. The pattern I is a pattern in which an image overlapping order does not contradict with specification of a user and the two objects are printed separately on the front surface and the back surface. Note that, when Image 4 is the first image, and Image 5 is the second image, the pattern K and the pattern L correspond to the first pattern, and the pattern I and the pattern J correspond to the second pattern.

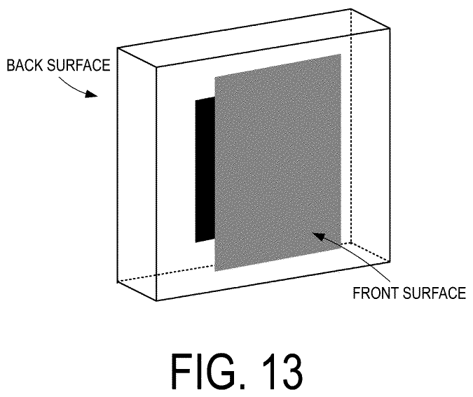

The pattern L that remains after excluding the excluded patterns as described above is provided. With this, a user can select the pattern in which printing is executed so that the second image behind the first image cannot be visually recognized when the front surface of the transparent medium is viewed in the direction vertical to the front surface of the transparent medium, but, as illustrated in FIG. 13, the second image printed on the back surface can be visually recognized via the thickness of the transparent medium when the transparent medium is viewed in a direction slightly inclined from the direction vertical to the front surface. Further, as illustrated in FIG. 11, a pattern in which the second image cannot be visually recognized due to printing on the same surface (the pattern K, the pattern L) and a pattern causing a printing result that contradicts an overlapping order specified by a user (the pattern J) can be excluded from the options for a user.

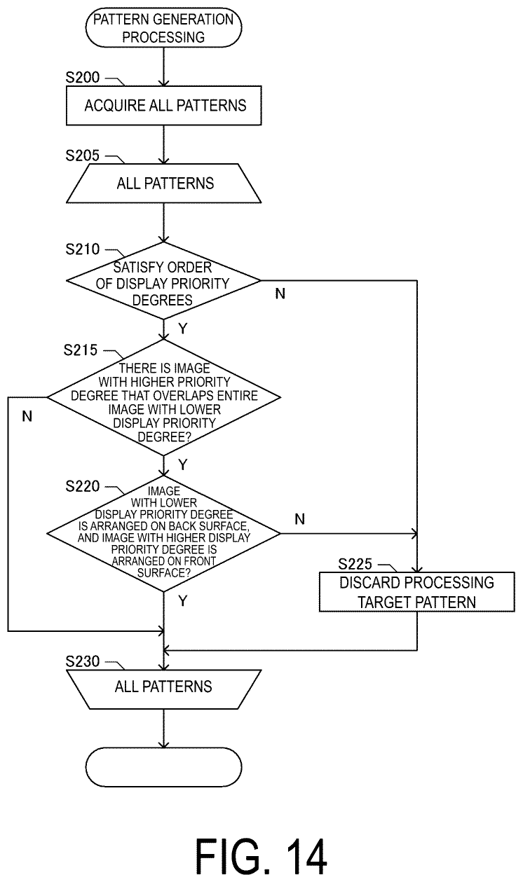

Next, with reference to FIG. 14, description is made on pattern generation processing for generating the patterns described above. The pattern generation processing is started when a user terminates creation and editing of an image. When the pattern generation processing is started, the processor 10a acquires all the patterns (Step S200). In other words, the processor 10a acquires 2M patterns, where M (M is a natural number) represents the number of images registered in the image list. Specifically, for example, when there are three images as in the example of FIG. 5, the eight patterns including the patterns A to H illustrated in FIG. 8 and FIG. 9 are acquired.

Subsequently, with regard to all the patterns acquired in Step S200, the processor 10a executes the processing Steps S205 to S230 for each of the patterns, determines whether each of the patterns is appropriate as a pattern provided to a user, and excludes a pattern, which is determined as inappropriate, from the proposal targets.

The processor 10a extracts one pattern from unprocessed patterns, as a processing target pattern, and executes the processing in Steps S205 to S230 therefor. In Step S210, it is determined whether the processing target pattern satisfies the order of the display priority degrees (Step S210). In other words, in a case in which interfering objects are present in the processing target pattern, when an object with a higher display priority degree of the two interfering objects is allocated on the back surface and the object with a lower display priority degree is allocated on the front surface, the processor 10a determines that the order of the display priority degrees is not satisfied (contradiction with the overlapping order). In other cases, the processor 10a determines that the order of the display priority degrees is satisfied. Specifically, for example, the processor 10a determines that the patterns A to E illustrated in FIG. 8 satisfy the order of the display priority degrees (the patterns do not contradict with the overlapping order), and determines that the patterns F to H illustrated in FIG. 9 do not satisfy the order of the display priority degrees (the patterns contradict with the overlapping order).

When it is not determined that the order of the display priority degrees is satisfied in Step S210, the processor 10a discards the processing target pattern (Step S225). In other words, the processing target pattern is excluded from the patterns provided to a user.

When it is determined that the priority degree order is satisfied in Step S210, the processor 10a determines whether an image with a higher priority degree overlaps with an entire image with a lower priority degree (Step S215). For example, the processor 10a determines whether the objects in the relationship described with reference to FIG. 10 are included.

When it is determined that such objects are present in Step S215, the processor 10a determines whether the processing target pattern is a pattern in which an image with a lower display priority degree is arranged on the back surface and an image with a higher display priority degree is arranged on the front surface (Step S220). For example, among the patterns illustrated in FIG. 11 and FIG. 12, the processor 10a determines the processing target pattern is not the patterns K and L but the pattern I. Note that when the processing target pattern is the pattern J, determination as NO is given in Step S210. Note that, in a case in which there are more than two pairs in which an image with a higher priority degree overlaps with an entire image with a lower priority degree, when at least one of the pairs satisfies the condition in S220, the processor 10a determines YES in Step S220.

When, in Step S220, the processing target pattern is not determined as a pattern in which an image with a lower priority degree is arranged on the back surface and an image with a higher priority degree is arranged on the front surface, the processor 10a discards the processing target pattern (Step S225). In other words, the processing target pattern is excluded from the patterns provided to a user.

In a case of determination as YES in Step S220, or a case of determination as NO in Step S215, the processor 10a does not discard the processing target pattern (in other words, the processing target pattern is to be provided). Further, the processor 10a returns to Step S210 when the processing is not completed for all the patterns, and terminates the pattern generation processing when the processing is completed therefor.

Incidentally, when an image created by a user is printed on the transparent medium, it is possible to execute printing with white ink as a base in a printing region of process color ink so as to enhance color vibrancy, or to apply clear ink over the region where printing is executed by using the process color ink so as to add a glossy finish. Thus, when layers using such types of special color ink can be printed, the processor 10a also provides possibilities of printing such layers for each pattern.

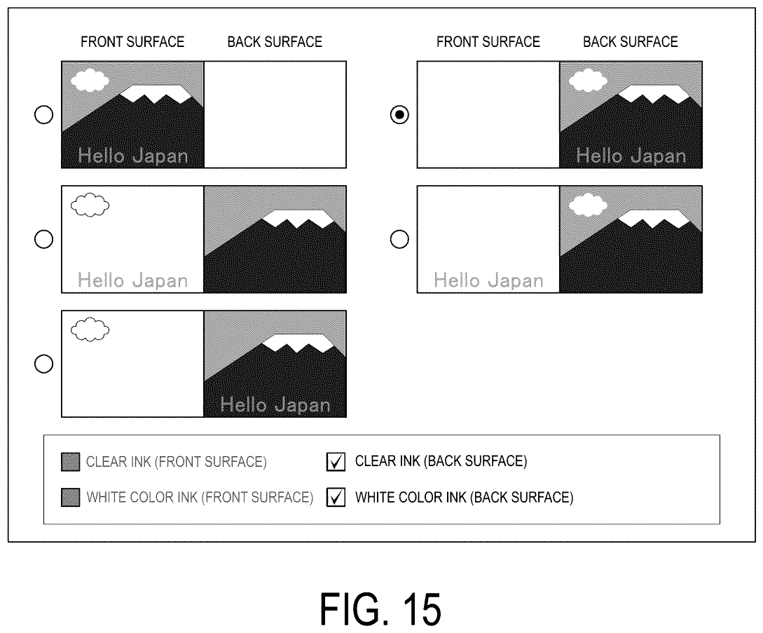

In the present embodiment, when one or more objects by the process color ink are allocated on the printing surface, the processor 10a determines that a clear ink layer can be printed. The transparent medium itself has a glossy finish, and hence printing by the clear ink is not required on a surface on which an object is not printed. Thus, the processor 10a does not allow printing by the clear ink on a surface on which one or more such objects are not allocated. For example, the back surface in the pattern A and the front surface in the pattern B in FIG. 7 correspond to this case. Note that, when viewing from the front surface is assumed in the present embodiment, in a pattern such as the patterns B to E in which a color layer is printed by the process color ink on the back surface, it may be configured that the clear ink after printing the color layer may not be required and may not be allowed. Alternatively, although the necessity is low, it may be configured that the selection is possible, as illustrated in FIG. 15. Note that, when a printed matter is produced while viewing from both the front surface and the back surface is assumed, in a pattern in which the color layer is printed on the back surface, it is advantageous to allow the selection of printing of the clear ink layer on the back surface after printing the color layer, for the purpose of providing a glossy finish in a case of viewing from the back surface.

With regard to the white color ink, the processor 10a allows printing by the white color ink as a base on the printing surface on which one or more objects are allocated. Further, on the back surface on which no object is allocated, such as the back surface in the pattern A in the example of FIG. 7, the processor 10a also allows printing by the white color ink as a base. When no object is allocated on the front surface as in the pattern B, the processor 10a does not allow printing by the white color ink on the front surface.

In this manner, the processor 10a further subdivides the patterns, considering a special color ink layer.

FIG. 15 illustrates an example of a screen displayed on the display unit 10d of the user terminal 10, the screen for providing a user with selectable patterns. The processor 10a displays a radio button for each pattern so that any one of the provided patterns can be selected. For each pattern, the processor 10a displays a printing preview of images allocated to the front surface and the back surface. The pattern is provided together with the printing preview. With this, for each pattern, a user can recognize a printing result acquired by selecting each pattern.

Further, with regard to the selected pattern, the processor 10a displays check boxes so that the clear ink layer and the white color ink layer can be selected on both the front surface and the back surface. For example, in the example of the image IM in FIG. 5, an image of the clear ink layer and an image of the white color ink layer can be created in addition to the first image, the second image, and the third image. Note that, for example, when the special color ink layer cannot be printed as on the front surface in the pattern B, the processor 10a displays the corresponding check box in a gray out manner so that a user cannot select the check box.

The screen illustrated in FIG. 15 is displayed to provide the patterns that can be selected by a user. With this, when printing is executed on the transparent medium having the front surface and the back surface on which printing can be executed, the processor 10a can cause a user to recognize the image allocation patterns on both the surfaces of the transparent medium. The check box for selecting whether to execute printing using the special color ink is also displayed. With this, a user can recognize the selectable patterns including images to be printed by the special color ink (the white color ink, the clear ink). A user selects any one of the provided patterns (including presence or absence of the white color ink layer or the clear ink layer), and executes an operation to instruct printing. With this, the processor 10a generates the printing data 10cl for executing printing in the selected pattern.

When a user selects to use the special color ink such as the white color ink and the clear ink, the processor 10a automatically generates an image of the special color ink layer by the white color ink or the clear ink, as an image having the same shape as a printing region of an object arranged on the printing surface. For example, in a case of the front surface in the pattern A in FIG. 8, the processor 10a generates an image having the same rectangle shape as Image 1 (the scenery image including a mountain and a sky), as an image of the white color ink layer or the clear ink layer. Further, for example, in a case of the front surface in the pattern C, the processor 10a generates an image having a shape acquired by combining Image 2 (cloud) and Image 3 (characters) with each other, as an image of the white color ink layer or the clear ink layer. In a case of the back surface in the pattern C, an image having the same rectangle shape as the scenery image of Image 1 is created as an image of the white color ink layer or the clear ink layer.

In this manner, the image of the special color ink layer is not an image prepared by a user, but is generated by executing the editing application by the processor 10a (the printing system) according to an image created by a user.

Further, based on a pattern selected by a user, the processor 10a generates the printing data 10c1 in which an image of each layer printed on each of the front surface and the back surface (including a special color ink layer when the special color ink is used) and the overlapping order thereof are defined. Then, the processor 10a transmits the printing data 10c1 to the server 30. For example, in the pattern C, the overlapping order is defined in the following order starting from the top layer of the front surface: the clear ink layer when the clear ink is selected, the color layer by the process color ink, the white color ink layer when the white color ink is selected, the transparent medium, the color layer by the process color ink, and the white color ink layer when the white color ink is selected (the clear ink layer when the clear ink is selected). The printing data 10c1 in which the overlapping order is thus defined is generated, and is transmitted to the server 30. The server 30 transmits the printing data 10cl to the printer 50 that executes printing based on the printing data 10c1, and causes the printer 50 to execute printing.

### (3) Other Embodiments

The embodiment described above are examples for implementing the present disclosure, and various other embodiments may be adopted. For example, the user terminal may be a terminal owned by a user, instead of a terminal prepared by a store. A location where the user terminal is used is not limited to a store, and the user terminal may be used at a house of a user or any other locations.

The device that functions as a display for providing, on a screen, an allocation pattern of images to be printed on a transparent medium may be a device other than a terminal operated by a user who places an order of a printed matter. For example, the device may be a terminal at a store front, which is operated by a store staff member when an order content is confirmed with a user, or may be a terminal operated by a printing worker who works at a back office.

Various methods of providing patterns may be adopted. For example, a method of expressing a pattern with words may be adopted. Alternatively, it may be configured that a pattern is provided together with a printing preview for printing each if the patterns. The printing preview may be expressed in a two-dimensional manner as in the above-mentioned embodiment. In other words, it may be configured that a printing preview of an allocated image is given for each of the front surface and the back surface. Alternatively, it may be configured that an image allocated to the front surface and an image allocated to the back surface are superposed on each other to express one two-dimensional image (for example, IM in FIG. 5). In such a case, for example, an image allocated to the back surface as in the pattern B in FIG. 8 and the like may be displayed by superposing a design indicating a glossy finish of the transparent medium itself so as to recreate the viewing through the transparent medium. Further, as illustrated in FIG. 13, the preview may be expressed in a three-dimensional manner. In other words, it may be configured that an allocated image is mapped and displayed in three-dimensional models indicating the front surface and the back surface of the transparent medium. The pattern is provided together with a printing preview for printing each pattern. With this, for each pattern, a user can recognize a printing result acquired by selecting each pattern.

In a case of focusing on two objects of a plurality of objects included in an image created by a user, all of the first pattern and the second pattern may be provided without excluding the above-mentioned excluded patterns. Further, in a case of focusing on three objects of a plurality of objects included in an image created by a user, all of the first pattern to the fourth pattern may be provided without excluding the above-mentioned excluded patterns. In such a case, the patterns may be displayed with printing previews therefor so that a user can check whether a finishing can be achieved as intended. There is also the possibility that a user may unexpectedly find a good finish that is not originally intended, which leads to a new realization.

The special color ink may include metal color ink. In other words, a layer printed by the metal color ink (metallic ink) may be included. It may be configured that, when an image created by a user includes a metal color, a user selects whether to use the metal color ink (when the metal color ink is not used, the process color ink is used for recreation). In such a case, a user can recognize the selectable patterns including images printed by the metal color ink. It may be configured that, when use of the metal color ink is selected, an image using the metal color ink is generated by the printing system.

Note that images of layers constituting a pattern may include an image automatically generated by the printing system. In other words, as described above, it may be configured that an image using the special color ink may be generated based on an image created by a user. Further, a user may create an image by using a pre-set image such as a character of each font, a decorative character, a frame, a stamp, and an image material. In this case, such a pre-set image corresponds to an image automatically generated by the printing system. For example, the cloud object in Image 2 may be an image material that is prepared in advance in the editing application. The character object in Image 3 may be an object created by using a character of a font that is prepared in advance in the editing application. With this configuration, a user can recognize the selectable patterns including an image generated by the printing system based on data prepared in advance in the printing system, in addition to an image prepared by a user.

In the embodiment described above, as illustrated in FIG. 15, a configuration of providing a check box is further adopted so that presence or absence of the special color ink layer can be selected for a pattern selected by a radio button. There may be adopted a configuration of simultaneously providing patterns including presence and absence of the special color ink layer and selecting any pattern therefrom. For example, in the case of FIG. 7, on the front surface in the pattern A, the clear ink layer is printed, and the white color ink is not printed. On the back surface, the clear ink layer is not printed, and the white color ink is printed. Such a combination is regarded as a pattern A1. Similarly, the front surface in the pattern A, both the clear ink layer and the white color ink layer are printed. On the back surface, the clear ink layer is not printed, and the white color ink is printed. Such a combination is regarded as a pattern A2. In this manner, all the combinations may be provided simultaneously. In such a case, the special color ink layer may be regarded equivalently to a freely selected layer included in an image created by a user (for example, Image 1, Image 2, and Image 3 in FIG. 5, and the like). Further, it is assumed that the special color ink layer is the second image and any layer of non-special color ink (for example, Image 1, Image 2, and Image 3 in FIG. 5, and the like) is the first image. Such a case is equivalent to a case of providing the plurality of patterns including the first pattern in which the first image and the second image are printed on the same surface side and the second pattern in which the first image and the second image are respectively printed on the opposite sides. It is assumed that the special color ink layer is further subdivided and the second image is a white color ink layer or a metal color ink layer. Similarly to the above-mentioned case in which the layer is regarded equivalently, such a case is equivalent to a case of providing the plurality of patterns including the first pattern and the second pattern.

In the embodiment described above, description is made as an example on a case in which the transparent medium having a front surface and a back surface on which printing can be printed is viewed from the front surface. As a matter of course, it may be assumed that the viewing is from both the surfaces. For example, as in the example illustrated in FIG. 10, when an image with a lower display priority degree overlaps completely with an image with a higher display priority degree, printing is executed while allocation to the front surface and the back surface is executed as in FIG. 13. With this, it is possible to produce a printed matter for which the viewing from both the front surface and the back surface is assumed.

Moreover, the present disclosure is applicable to a program and a method that are executed by a computer. For example, the present disclosure is also achieved as a disclosure of a printing program for causing a computer to achieve a function of causing a display to provide a plurality of patterns including a first pattern in which a first image and a second image are printed on the same surface side of a transparent medium and a second pattern in which the first image and the second image are respectively printed on opposite sides of the transparent medium, and a function of causing a printer to execute printing according to a pattern selected by a user from the patterns being provided. Further, the present disclosure is also achieved as a disclosure of a method of producing a printed material, including providing a plurality of patterns including a first pattern in which a first image and a second image are printed on the same surface side of a transparent medium and a second pattern in which the first image and the second image are respectively printed on opposite sides of the transparent medium, and executing printing according to a pattern selected by a user from the patterns being provided.

Further, the system, the program, and the method that are described above may be achieved as a single and independent device, or may be achieved by utilizing components included in a plurality of devices. Thus, various modes may be adopted. Further, modifications may be made as appropriate by, for example, configuring some parts as software or hardware. Moreover, the present disclosure is also achieved as a recording medium for a program that controls a system. As a matter of course, a recording medium for the program may be an electro-magnetic medium or a semiconductor medium. The same can be considered for any recording media that may be developed in the future.

What is claimed is:

1. A printing system comprising:
a display configured to provide a plurality of patterns including a first pattern in which a first image and a second image are printed on the same surface side of a transparent medium and a second pattern in which the first image and the second image are respectively printed on opposite sides of the transparent medium; and
a printer configured to execute printing according to a pattern selected by a user from the patterns being provided.

2. A printing system according to claim 1, wherein
the display provides a plurality of patterns including:
a first pattern in which the first image, the second image, and a third image are printed on the same surface side of the transparent medium;
a second pattern in which the first image, and the second image and the third image are respectively printed on the opposite sides of the transparent medium;
a third pattern in which the first image and the third image, and the second image are respectively printed on the opposite sides of the transparent medium; and
a fourth pattern in which the third image, and the first image and the second image are respectively printed on the opposite sides of the transparent medium.

3. A printing system according to claim 1, wherein
the display provides a plurality of patterns while excluding a pattern causing a printing result that contradicts with an image overlapping order specified by a user.

4. A printing system according to claim 1, wherein
when a user specifies the first image as an layer above the second image, and a printing region of the first image includes a printing region of the second image, the display excludes:
a pattern in which the first image and the second image are printed on the same surface side; and
a pattern in which the first image is printed on a back surface of the transparent medium and the second image is printed on a front surface of the transparent medium, and
the display provides a pattern in which the first image is printed on the front surface of the transparent medium and the second image is printed on the back surface of the transparent medium.

5. A printing system according to claim 1, wherein
the display also provides a printing preview for printing each if the patterns.

6. A printing system according to claim 1, wherein
at least any one of the first image and the second image is generated by the printing system.

7. A printing system according to claim 6, wherein
at least any one of the first image and the second image is an image to be printed with special color ink.

8. A printing system according to claim 7, wherein
at least any one of the first image and the second image is an image to be printed with white color ink, metal color ink, or clear ink.

9. A non-transitory computer-readable storage medium storing a printing program for causing a computer to achieve:
a function of causing a display to provide a plurality of patterns including a first pattern in which a first image and a second image are printed on the same surface side of a transparent medium and a second pattern in which the first image and the second image are respectively printed on opposite sides of the transparent medium; and
a function of causing a printer to execute printing according to a pattern selected by a user from the patterns being provided.

10. A method of producing a printed matter comprising:
providing a plurality of patterns including a first pattern in which a first image and a second image are printed on the same surface side of a transparent medium and a second pattern in which the first image and the second image are respectively printed on opposite sides of the transparent medium; and
executing printing according to a pattern selected by a user from the patterns being provided.
